(19) United States
(12) Patent Application Publication
(10) Pub. No.: US 2007/0206006 A1
(43) Pub. Date: Sep. 6, 2007

(54) 3D point-based modeling system, medium, and method

(75) Inventors: Shin-jun Lee, Seoul (KR); Gyeong-ja Jang, Yongin-si (KR); Seok-yoon Jung, Seoul (KR); Do-kyoon Kim, Seongnam-si (KR); Keun-ho Kim, Seoul (KR); Hee-see Lee, Yongin-si (KR); Alexei Sosnov, Moscow (RU); Alexander Zhirkov, Moscow (RU); Alexander Parshin, Moscow (RU); Andrey Iliyi, Moscow (RU); Maxim Fodyukoy, Moscow (RU); Boris Mihajiovic, Moscow (RU)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/706,208

(22) Filed: Feb. 15, 2007

(30) Foreign Application Priority Data
Feb. 15, 2006 (KR) 10-2006-0014720

(51) Int. Cl. G06T 17/00

(52) U.S. Cl. 345/420

(57) ABSTRACT

A 3-dimensional (3D) point-based modeling system, medium, and method, with system generating scene information by using point information in relation to a 3D polygon object and position, rotation, and size information of a 3D polygon object in a scene such that the modeling speed of a 3D image can be enhanced, the entire scene being effectively managed, and the resolution in relation to each object can being adjusted conveniently.

### CROSS-REFERENCE TO RELATED APPLICATIONS

This application claims the benefit of Korean Patent Application No. 10-2006-0014720, filed on Feb. 15, 2006, in the Korean Intellectual Property Office, the disclosure of which is incorporated herein in its entirety by reference.

### BACKGROUND

1. Field of the Invention

One or more embodiments of the present invention relate to a graphic tool of a 3-dimensional (3D) image, and more particularly, to a system, medium, and method modeling a 3D image.

2. Description of the Related Art

A depth image based representation (DIBR) is a technique for synthesizing a scene at an arbitrary time by using inputs of still or moving picture color and/or depth information according to point or pixel. DIBR includes a process of projecting points or pixels of an original image onto a 3D world by using respective depth information, and a process of projecting points on this 3D space onto an image plane of a virtual camera located at a preset viewing position. That is, DIBR includes the process of a 2D-3D projection followed by another process of 3D-2D projection. For DIBR, virtual cameras are installed/designated at a plurality of positions centering around an object and a plurality of images are obtained. Virtual cameras are installed/designated to be arranged in front of, at the back of, to the right of, to the left of, above and below an object, or more cameras are installed/designated at appropriate positions such that color information and depth information of the object can be obtained.

However, since this convention DIBR technique uses the plurality of virtual cameras to obtain images, and a process of generating virtual cameras is required, the operational speed is low. This problem becomes more serious if an object has a complicated shape and requires more virtual cameras. In addition, with respect to the complexity of an object, the areas and positioning of virtual cameras should be set directly by a user. Furthermore, a camera bounding volume in a square shape surrounding an object should be adjusted manually, resulting in the quality of a picture depending on the ability of a user. Though the resolution of each of the objects of a scene can be individually adjusted, this requires an annoying operation of individually managing the resolution to generate a scene.

### SUMMARY

One or more embodiments of the present invention provide a 3D point-based modeling system, medium, and method capable of enhancing the modeling speed of a 3D image, thereby enabling efficient management of an entire scene.

Additional aspects and/or advantages of the invention will be set forth in part in the description which follows and, in part, will be apparent from the description, or may be learned by practice of the invention.

To achieve the above and/or other aspects and advantages, embodiments of the present invention include a 3-dimensional (3D) point-based modeling method, including extracting central points of respective grid cells to be divided, as point information, when a 3D polygon object is divided into a plurality of grid cells, generating at least one node including object information in relation to the 3D polygon object in a scene, and generating scene information including the 3D polygon object by using the extracted point information and the object information of the at least one generated node.

To achieve the above and/or other aspects and advantages, embodiments of the present invention include at least one medium including computer readable code to control at least one processing element to implement an embodiment of the present invention.

To achieve the above and/or other aspects and advantages, embodiments of the present invention include a 3D point-based modeling system, including a point information extraction unit to extract central points of respective grid cells to be divided, as point information, when a 3D polygon object is divided into a plurality of grid cells, a node generation unit to generate at least one node including object information in relation to the 3D polygon object in a scene, and a scene information generation unit to generate scene information including the 3D polygon object by using the extracted point information and the object information of the at least one generated node.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a 3-dimensional (3D) point-based modeling system, according to an embodiment of the present invention;

FIG. 2 illustrates a kettle as an example of a 3D polygon object, according to an embodiment of the present invention;

FIG. 3 illustrates a point information extraction unit, such as that shown in FIG. 1, according to an embodiment of the present invention;

FIG. 4 illustrates an example in which the 3D polygon object, such as shown in FIG. 2, is divided according to the number of sampling lines, according to an embodiment of the present invention;

FIG. 5 illustrates grid cells, according to an embodiment of the present invention;

FIG. 6 illustrates a hierarchical structure, according to an embodiment of the present invention;

FIG. 7 illustrates an example of geometry information and color information in relation to one grid cell, according to an embodiment of the present invention;

FIG. 8 illustrates an example of geometry information and color information in relation to 8 grid cells obtained by dividing the grid cell of FIG. 7 by 8 according to an embodiment of the present invention;

FIG. 9 illustrates an example of geometry information and color information in relation to 8 grid cells obtained by dividing each grid cell of FIG. 8 according to an embodiment of the present invention;

FIG. 10 illustrates an example in which point information in relation to an object, such as that shown in FIG. 2, is stored in a binary volume octree format including color information, according to an embodiment of the present invention;

FIG. 11 illustrates an example of a 3D scene expressed with a plurality of objects, according to an embodiment of the present invention;

FIG. 12 is a flowchart illustrating a 3D point-based modeling method, according to an embodiment of the present invention; and

FIG. 13 is a flowchart illustrating an operation 600 shown in FIG. 12, according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

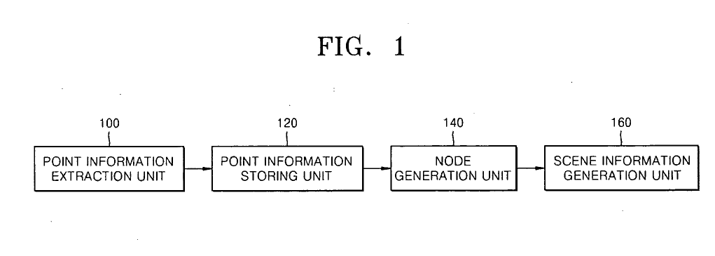

FIG. 1 illustrates a 3-dimensional (3D) point-based modeling system, according to an embodiment of the present invention, which may include a point information extraction unit 100, a point information storing unit 120, a node generation unit 140, and a scene information generation unit 160, for example.

When a 3D polygon object is divided into a plurality of grid cells, the point information extraction unit 100 may extract the central point of each grid cell as point information and output the extracted results to the point information storing unit 120.

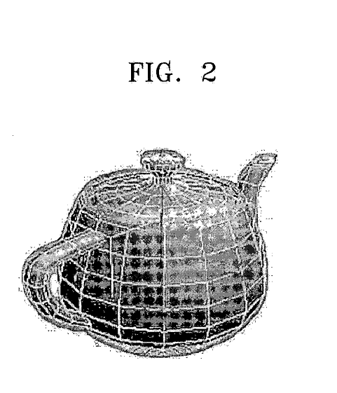

For example, FIG. 2 illustrates a kettle of a 3D polygon object, according to an embodiment of the present invention. As illustrated in FIG. 2, it can be confirmed that the kettle is formed as a combination of a number of polygons.

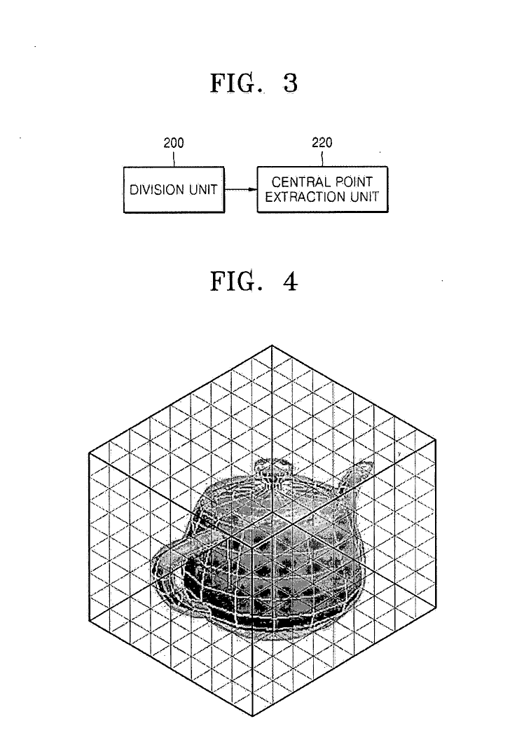

FIG. 3 illustrates a point information extraction unit, such as that shown in FIG. 1, according to an embodiment of the present invention. The point information extraction unit 100 may include a division unit 200 and a central point extraction unit 220, for example. The division unit 200 may extract a bounding volume of a predetermined size in relation to a 3D polygon object, and by using a plurality of sampling lines, divides the bounding volume and outputs the divided results to the central point extraction unit 220. More specifically, the division unit 200 may extract a square-shaped bounding volume, for example, with a minimum size to include a 3D polygon object. That is, in one embodiment, the division unit 200 extracts the bounding volume having a minimum size wrapping the surface of an object.

After the bounding volume is extracted, the division unit 200 may determine the number of sampling lines corresponding to the resolution with respect to modeling. That is, the number of sampling lines increases with the increasing point resolution. The division unit 200 can divide the bounding volume according to the number of sampling lines in a conventional graphic authoring tool such as 3DS Max or Maya as an authoring tool.

FIG. 4 illustrates an example in which the 3D polygon object, such as that shown in FIG. 2, is divided according to the number of sampling lines, according to an embodiment of the present invention. As illustrated in FIG. 4, it can be seen that the bounding volume surrounding a 3D polygon object has been divided into a plurality of grid cells. The central point extraction unit 220 extracts central points of grid cells including polygons forming the 3D polygon object, as respective point information, among the grid cells of the bounding volume divided in the division unit 200. First, the central point extraction unit 220 can extract grid cells including a polygon. Then, the central point extraction unit 220 can orthographically project the central point of an extracted grid cell on the corresponding polygon surface, and if the project point is included in the corresponding grid cell, extract the point as a valid central point. The central point thus extracted is the point information.

According to an embodiment of the present invention, the point information storing unit 120 may store the point information extracted in the point information extraction unit 100 in a hierarchical structure including color information. In particular, the point information storing unit 120 may store the point information in a binary volume octree format, including color information as a hierarchical structure.

In an embodiment, a colored binary volumetric octree (CBVO) format includes header information, geometry information, and color information. An example of the CBVO format is shown in the below Table 1.

TABLE 1

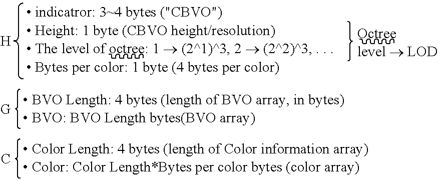

Here, the identified H portion indicates header information, which may include ‘indicator’, ‘Height’, ‘level of octree’, and ‘Bytes per color’, for example. In an embodiment, the ‘indicator’ indicates that the point information has a CBVO format, the ‘Height’ includes resolution information in relation to a 3D object, the ‘level of octree’ includes level information of an octree, and the ‘Bytes per color’ includes information on the number of bytes in relation to each color.

The identified G portion represents geometry information, which may include layer information in relation to point information. That is, the geometry information may include the number of grid cells and information on whether or not information exists in each grid cell.

The identified C portion represents color information, which may include information on color of point information with respect to the layer structure. In particular, the color information may include red, green, blue and transparency as information, for example.

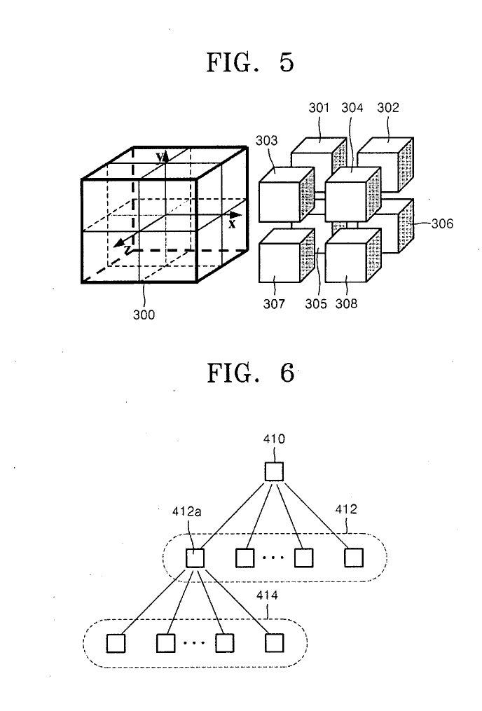

FIG. 5 illustrates grid cells, according to an embodiment of the present invention. Referring to FIG. 5, the bounding volume 300 of a 3D object can be divided into a plurality of grid cells 301 through 308, for example. In addition, in an embodiment, the plurality of grid cells 301 through 308 can be further divided into sub grid cells (not shown).

FIG. 6 illustrates a layer structure, according to an embodiment of the present invention. The layer structure means a tree structure having upper and/or lower levels. Each element forming the layer structure is referred to as a node. Here, each node on a tree structure can match a plurality of sub nodes, and an upper node and a lower node may also be referred to as a parent node and a child node, respectively. In the tree structure of FIG. 6, a parent node 410 has a plurality of children nodes 412, and a parent node 412a has a plurality of children node 414, for example.

In this example, reference number 410 corresponds to reference number 300, and reference number 412 corresponds to reference numbers 301 through 308. Accordingly, as illustrated, reference number 412 has the plurality of children nodes 414. If a bounding volume is divided into 8 grid cells and each of the divided grid cells is divided again into 8 grid cells, this structure is referred to as an octree structure.

If an octree structure is formed using color information of each respective grid cell, it is called a color binary volumetric octree (CBVO) format. This CBVO format is a particular format, e.g., a binary data, and is distinguished from an ASCII code or text code. The geometry information of a CBVO format can be defined according to the below Equation 1.
BVO=[a b c d e f g h] Equation 1:

Here, a through h indicate information items of 8 grid cells, respectively, existing on a predetermined level. Each of a through h can be expressed as “1” or “0”, i.e., binary data, for example.

A “0” may indicate that information does not exist in the corresponding grid cell, and a “1” may indicate that information exists in the corresponding grid cell.

The color information of the CBVO format is defined as the below Equation 2.
Color=[R G B A] Equation 2:

Here, R, G, and B can be expressed by hexadecimal codes to indicate whether or not red (R), green (G), and blue (B) exist in a grid cell, and A may be expressed by a hexadecimal code to indicate the transparency of a grid cell.

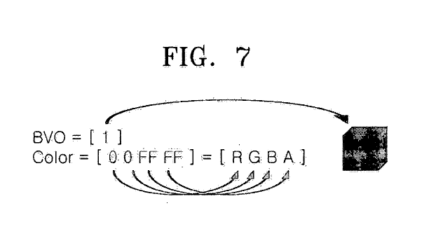

FIG. 7 illustrates an example of geometry information and color information in relation to one grid cell, according to an embodiment of the present invention. As illustrated in FIG. 7, it can be seen that geometry information in relation to one grid cell is represented by BVO=[1], and color information is represented by Color=[R G B A]=[0 0 FF FF].

Since BVO is a “1”, this means that there is a grid cell. Further, since R and G are “0's”, this means that red and green do not exist in this grid cell, since B is FF, this means that blue color exists in this grid cell, and since A is FF, this means that this grid cell is opaque.

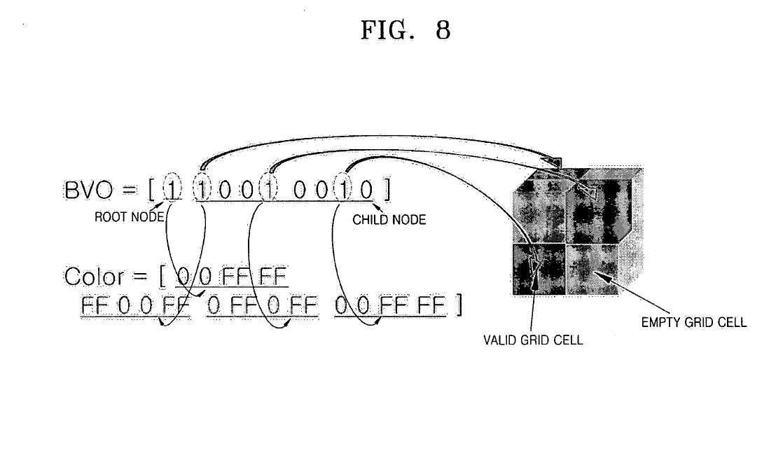

FIG. 8 illustrates an example of geometry information and color information in relation to 8 grid cells obtained by dividing the grid cell of FIG. 7 by 8, according to an embodiment of the present invention. As illustrated in FIG. 8, it can be seen that geometry information in relation to 8 grid cells is represented by BVO=[1 1 0 0 1 0 0 1 0], and color information is represented by Color=[0 0 FF FF FF 0 0 FF 0 FF 0 FF 0 0 FF FF].

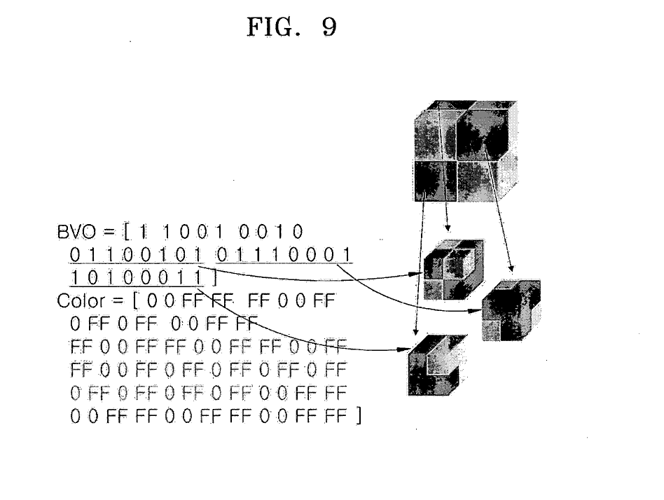

FIG. 9 illustrates an example of geometry information and color information in relation to 8 grid cells obtained by dividing each grid cell of FIG. 8, according to an embodiment of the present invention. As illustrated in FIG. 8, it can be seen that geometry information in relation to 8 grid cells is represented by BVO=[1 1 0 0 1 0 0 1 0 0 1 1 0 0 1 0 1 0 1 1 1 0 0 0 1 1 0 1 0 0 0 1 1] and color information is represented by Color=[0 0 FF FF FF 0 0 FF 0 FF 0 FF 0 0 FF FF FF 0 0 FF FF 0 0 FF FF 0 0 FF FF 0 0 FF O FF 0 FF O FF 0 FF O FF 0 FF 0 FF 0 FF 0 0 FF FF 0 0 FF FF 0 0 FF FF 0 0 FF FF 0 0 FF FF].

In a further embodiment, the point information storing unit 120 may store the point information extracted in the point information extraction unit 100 in the binary volumetric octree format described above, and output the stored result to the node generation unit 140, for example.

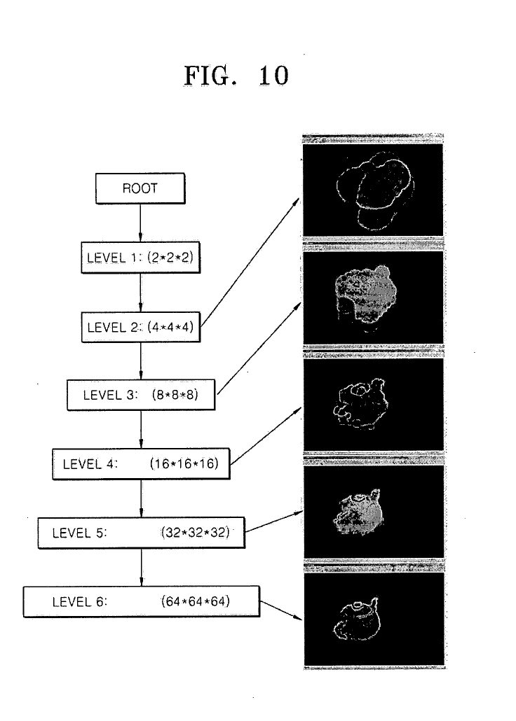

FIG. 10 illustrates an example in which point information in relation to an object, such as that shown in FIG. 2, is stored in a binary volume octree format including color information, according to an embodiment of the present invention. As illustrated in FIG. 10, it can be seen that the accuracy of modeling in relation to an object increases in a lower level. The node generation unit 140, thus, may generate a node including object information in relation to a 3D polygon object of a scene.

More specifically, the node generation unit 140 may generate a node including position, rotation, size and object name information of the 3D polygon object as object information. An example of object information in relation to a 3D polygon object, expressed in a virtual reality modeling language (VRML), for example, is shown in the below Table 2.

TABLE 2

CBVO{

| | | |
|---|---|---|
| VrmlSFVec3f | translation | 0 0 0 |
| VrmlSFRotation | rotation | 0 0 1 0 |
| VrmlSFFloat | scale | 10 |
| VrmlSFString | cbvofile | NULL |

}

Here, ‘translation’ indicates position information of the object, ‘rotation’ indicates rotation information of the object, ‘scale’ indicates the size information of the object, and ‘cbvofile’ indicate the object name of the object, for example.

The position information can be coordinate values in relation to a position at which the object is located in the scene. By using the position information, it can be known in which point of the scene the object is positioned. The rotation information indicates how much the object is rotated. Through the rotation information, it can be determined how much the object is rotated and expressed on the scene when it is seen from the front. The size information indicates the size of the object on the scene, and the object name information indicates the name of the object. The node generation unit 140, e.g., as described above, may generate a node for each of the 3D polygon objects and output the generated nodes and received point information to the scene information generation unit 160, for example.

The scene information generation unit 160 may generate scene information by using the object information on respective nodes generated in the node generation unit 140 and point information. For example, by using a VRML, which is a descriptive language for graphics data expressing a 3D space, generation of scene information can be described.

If nodes having object information on respective objects are received from the node generation unit 140, for example, the scene information generation unit 160 may recognize/determine the received position, rotation, and size information of respective nodes as upper-level nodes on a scene graph in relation to 3D polygon objects, and by using the position, rotation and size information of these nodes and point information of 3D polygon objects, generate scene information including 3D polygons.

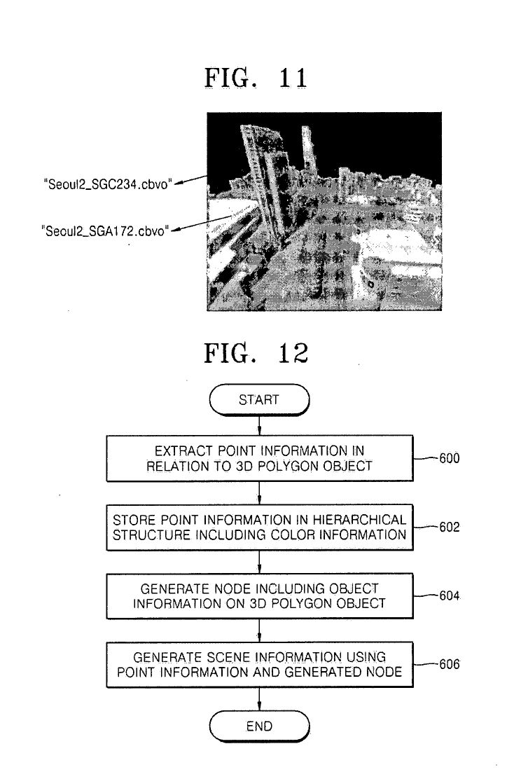

FIG. 11 illustrates an example of a 3D scene expressed with a plurality of objects, according to an embodiment of the present invention. In an embodiment, an example of scene information generated by using nodes in relation to respective objects illustrated in FIG. 11 may be expressed in the VRML in the below Table 3.

TABLE 3

Transform {
children [

CBVO {

translation −1469.137207 −1889.493774 0.690300
rotation 1 0 0 0.0000
scale 9.913331
cbvofile “Seoul2_SGC234.cbvo”

```
  }
CBVO {
  translation −1324.880371 −1870.194214 0.690300
  rotation 1 0 0 0.0000
  scale 9.913327
  cbvofile “Seoul2_SGA172.cbvo”
}
...
```

]
}

As shown in Table 3, scene information may be expressed by using the node of an object having an object name “Seoul2_SGC234.cbvo” and the node of an object having an object name “Seoul2_SGA172.cbvo” and nodes in relation to other objects. As described above, by storing information in a binary octree format, including color information in relation to a 3D object, generation of a virtual camera is not needed, and by storing 3D object data in a hierarchical structure, the resolution can be adjusted. In addition, the position, rotation, and size information of a 3D object itself on a scene is generated and by adjusting this position, rotation, and size information, the entire scene can be effectively managed in the modeling of the 3D scene.

A 3D point-based modeling method, according to an embodiment of the present invention, will now be explained in more detail.

FIG. 12 is a flowchart illustrating a 3D point-based modeling method, according to an embodiment of the present invention.

First, when a 3D polygon object is divided into a plurality of grid cells, central points of respective grid cells may be extracted as point information, in operation 600.

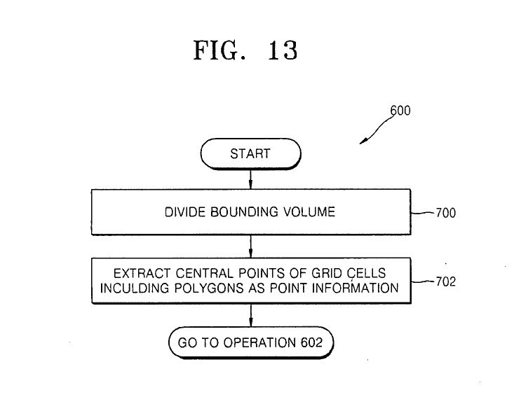

More specifically, FIG. 13 illustrates an example of this operation 600, according to an embodiment of the present invention.

First, a bounding volume of a predetermined size in relation to a 3D polygon object may be extracted, and by using a plurality of sampling lines, the bounding volume may be divided, in operation 700. In particular, a square-shaped bounding volume, for example, with a minimum size including the 3D polygon object may be extracted. That is, in an embodiment, a bounding volume having a minimum size wrapping the surface of the object is extracted. After the bounding volume is extracted, the number of sampling lines may be determined corresponding to a resolution with respect to the modeling, noting that the number of sampling lines may be determined according to a resolution in proportion to a point resolution.

For the sampling, the bounding volume may be divided according to the number of sampling lines using a conventional graphic authoring tool such as 3DS Max or Maya, for example. As an example, and as illustrated in FIG. 4, it can be seen that the bounding volume surrounding a 3D polygon object has been divided into a plurality of grid cells.

After operation 700, central points of grid cells including polygons forming 3D polygon objects may be extracted as respective point information among grid cells of the divided bounding volume, in operation 702. After grid cells including polygons are extracted, the central point of an extracted grid cell may be orthographically projected on the corresponding polygon surface, and if the project point is included in the corresponding grid cell, the point is extracted as a valid central point. The central point thus extracted may be the point information.

Meanwhile, with reference to FIG. 12, after operation 600, extracted point information may be stored in a layer structure including color information, in operation 602. In particular, in an embodiment, the information may be stored in a binary volumetric octree format as a layer structure.

If a bounding volume is divided into 8 grid cells, and each of the divided grid cells is divided again into 8 grid cells, this structure is defined as an octree structure.

If an octree structure is formed using respective color information of each grid cell, it is called a color binary volumetric octree (CBVO) format. As noted above, the CBVO format can be a binary format and is distinguished from an ASCII code or text code. The binary volumetric octree format including color information includes header information, geometry information and color information, as shown in Table 1 described above.

In addition, as noted above, the header information may include information on whether the point information has a CBVO format, and information on resolution in relation to a 3D object, level information of the octree, and information on the number of bytes in relation to each color. The geometry information may include layer structure information in relation to point information, i.e., the geometry information may include the number of grid cells and information on whether or not information exists in each grid cell.

The color information may include information on color of point information with respect to the layer structure. In particular, the color information may include red, green, blue and transparency as information items, for example. The geometry information in the CBVO format can be defined by the above Equation 1, and the color information of the CBVO format can be defined by the above Equation 2.

Examples of geometry information and color information, in relation to each grid cell, are illustrated in FIGS. 7 through 9. In addition, as illustrated in FIG. 10, point information is included in a CBVO format in relation to each grid cell.

After operation 602, a node including object information in relation to a 3D polygon object in a scene may be generated, in operation 604.

A node including position, rotation, size and object name information, in relation to a 3D polygon object, may be generated as object information.

The above Table 2 shows an example expressing object information in relation to a 3D polygon object.

After operation 604, scene information may be generated using point information and generated nodes, in operation 606. By referring to the aforementioned position, rotation and size information of nodes having object information in relation to respective objects, scene information expressing a scene with respect to the positions, rotation degrees, and sizes of respective objects on the scene may be generated.

An example of scene information generated by using nodes in relation to respective objects illustrated in FIG. 11 has similarly been expressed above in Table 3. As shown in Table 3, scene information may be expressed by using the node of an object having an object name “Seoul2_SGC234.cbvo” and the node of an object having an object name “Seoul2_SGA172.cbvo” and nodes in relation to other objects.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

According to a 3D point-based modeling system, medium, and method embodiment of the present invention, scene information may be generated by using point information in relation to a 3D polygon object and position, rotation, and size information of a 3D polygon object in a scene. Accordingly, virtual cameras do not need to be generated such that the speed of modeling can be enhanced.

In addition, according to a 3D point-based modeling system, medium, and method embodiment of the present invention, a scene can be edited by adjusting only position, rotation and size information in relation to a 3D polygon object in order to generate a scene having a similar 3D object. Accordingly, an entire scene can be effectively managed in the modeling of a 3D scene.

Furthermore, according to a 3D point-based modeling system, medium, and method embodiment of the present invention, point information may be stored in a binary volumetric octree format including color information, and by using this point information and nodes, scene information is generated such that the resolution in relation to an object in a scene can be effectively adjusted.

While the 3D point-based modeling system, medium, and method according to the present invention has been particularly shown and described with reference to some embodiments thereof, it would be appreciated by those skilled in the art that changes may be made in these embodiments without departing from the principles and spirit of the invention, the scope of which is defined at least in the claims and their equivalents.

What is claimed is:

1. A 3-dimensional (3D) point-based modeling method, comprising:
extracting central points of respective grid cells to be divided, as point information, when a 3D polygon object is divided into a plurality of grid cells;
generating at least one node including object information in relation to the 3D polygon object in a scene; and
generating scene information including the 3D polygon object by using the extracted point information and the object information of the at least one generated node.

2. The method of claim 1, wherein the extracting of the point information comprises:
extracting bounding volumes of predetermined sizes in relation to the 3D polygon object and dividing the bounding volumes by using a plurality of respective sampling lines; and
extracting the central points of the grid cells including polygons forming the 3D polygon object, as the point information, among plural grid cells with each of the divided bounding volumes.

3. The method of claim 2, wherein, in the dividing of the bounding volumes, a bounding volume with a minimum size including the 3D polygon object is extracted, a number of respective sampling lines is determined corresponding to a resolution with respect to modeling, and the bounding volume is divided by the number of the sampling lines.

4. The method of claim 1, further comprising implementing the extracted point information in a layer structure comprising color information.

5. The method of claim 4, wherein the layer structure is a binary volumetric octree format comprising the color information.

6. The method of claim 5, wherein the binary volumetric octree format further comprises header information, geometry information, and the color information.

7. The method of claim 6, wherein the header information comprises resolution information.

8. The method of claim 6, wherein the geometry information comprises layer structure information in relation to the point information.

9. The method of claim 6, wherein the color information comprises color information of the point information with respect to the layer structure.

10. The method of claim 9, wherein the color information comprises red, green, blue and transparency information as information items.

11. The method of claim 1, wherein, in the generating of the at least one node, a node comprising position, rotation, size, and object name information in relation to the 3D polygon object as object information is generated.

12. At least one medium comprising computer readable code to control at least one processing element to implement the method of claim 1.

13. A 3D point-based modeling system, comprising:
a point information extraction unit to extract central points of respective grid cells to be divided, as point information, when a 3D polygon object is divided into a plurality of grid cells;
a node generation unit to generate at least one node including object information in relation to the 3D polygon object in a scene; and
a scene information generation unit to generate scene information including the 3D polygon object by using the extracted point information and the object information of the at least one generated node.

14. The system of claim 13, wherein the point information extraction unit comprises:
a division unit to extract bounding volumes of predetermined sizes in relation to the 3D polygon object and divide the bounding volumes by using a plurality of respective sampling lines; and
a central point extraction unit to extract the central points of the grid cells including polygons forming the 3D polygon object, as the point information, among plural grid cells within each of the divided bounding volumes.

15. The system of claim 14, wherein the division unit extracts a bounding volume with a minimum size including the 3D polygon object, determines a number of respective sampling lines corresponding to a resolution with respect to modeling, and divides the bounding volume by the number of the sampling lines.

16. The system of claim 13, further comprising a point information storing unit to implement the extracted point information in a layer structure comprising color information.

17. The system of claim 16, wherein the layer structure is a binary volumetric octree format comprising the color information.

18. The system of claim 17, wherein the binary volumetric octree format further comprises header information, geometry information, and the color information.

19. The system of claim 13, wherein the node generation unit generates a node comprising position, rotation, size, and object name information in relation to the 3D polygon object as the object information.
